(19) United States
(12) Patent Application Publication
(10) Pub. No.: US 2002/0124973 A1
(43) Pub. Date: Sep. 12, 2002

(54) Safety edge for horizontally pivoted rolling gates

(76) Inventor: Francesco Albiero, Desenzano Del Garda (IT)

Correspondence Address: MCGLEW & TUTTLE, PC, SCARBOROUGH STATION, SCARBOROUGH, NY, 10510, US

(21) Appl. No.: 10/093,315

(22) Filed: Mar. 7, 2002

(30) Foreign Application Priority Data
Mar. 12, 2001 (IT) BS2001A000019

(51) Int. Cl. E05D 15/16

(52) U.S. Cl. 160/201

(57) ABSTRACT

The invention relates to a safety edge for horizontally pivoted rolling gates actuated by a motor unit. It consists of a profile (11) made of rubber or other soft flexible material and having a base (14) for its application to a rolling date, and of two electrical conductors (15, 16) extending longitudinally into the soft profile, parallel and normally separate from one another. The conductors move closer in the presence of a deforming thrust on said profile, to come into contact and enable an electrical circuit to send a signal for stopping the rolling gate motor unit.

### FIELD OF APPLICATION

The present finding relates to the field of horizontally pivoted rolling gates and similar automated devices, and in particular, it relates to a safety edge applicable as safety means to such closing systems.

### PRIOR ART

The application of a so-called safety edge to horizontally pivoted rolling gates is already known. It consists of a rubber or soft material profile and a traction cable extending into the rubber profile and connecting to at least one microswitch, normally closed, inserted in the electrical circuit of the motor controlling the rolling gate. Since the edge is not stressed, the microswitch remains closed and the rolling gate is not enabled to operate regularly. If, on the other hand, during the rolling gate movement, usually while closing, the edge detects or interferes with a foreign element that hinders it motion, the stressed cable causes the microswitch to open, thus opening the electrical circuit of the motor unit and stopping the rolling gate to prevent damages to people or things.

In such safety edge, the cable essentially has the function of actuating means for the mechanical drive of a control to at least one microswitch. In another embodiment, a safety edge to be used on rolling gates uses laminations or crop ends of laminations s actuators, but always associated to current switches.

### PURPOSE AND SUMMARY OF THE INVENTION

Purpose of the present finding is that of implementing and providing an improved safety edge for motor-driven rolling gates embedding electrical conductor means for its entire length, and acting at the same time, in any part of the edge, as means for stopping the rolling gate motor unit when the edge comes into contact with an obstacle, or is in any case stressed by a thrust.

Another purpose of the invention is that of providing a high-efficiency safety edge for rolling gates, easy to realise and convenient to be installed without having to use special angle joins when the edge is arranged on more sides of a rolling gate.

Such purposes are obtained, according to the present finding, by a safety edge for motor-driven rolling gates consisting of a rubber profile, or made of another soft, flexible material, and of two electrical conductors extending longitudinally into said profile in parallel, normally separate from one another and movable closer to come into contact in the presence of a deforming thrust on said profile and enable an electrical circuit to send a signal for stopping the rolling gate motor unit.

### BRIEF DESCRIPTION OF THE DRAWINGS

Further features of the invention will appear more clearly from the following description, made with reference to the attached indicative and non-limiting drawings. In such drawings

FIG. 1 shows a perspective view of a crop end of safety edge;

FIG. 2 shows a transversal section of the safety edge; and

FIG. 3 schematically shows a horizontally pivoted rolling gate complete with safety edge.

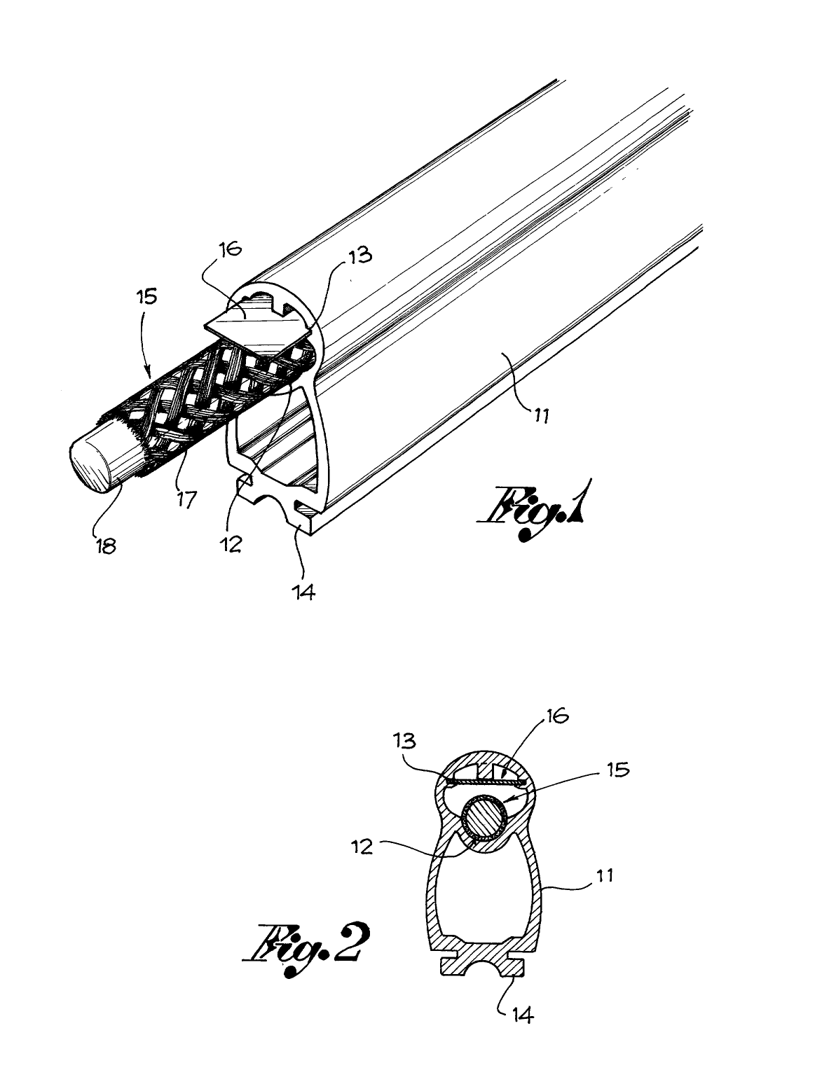

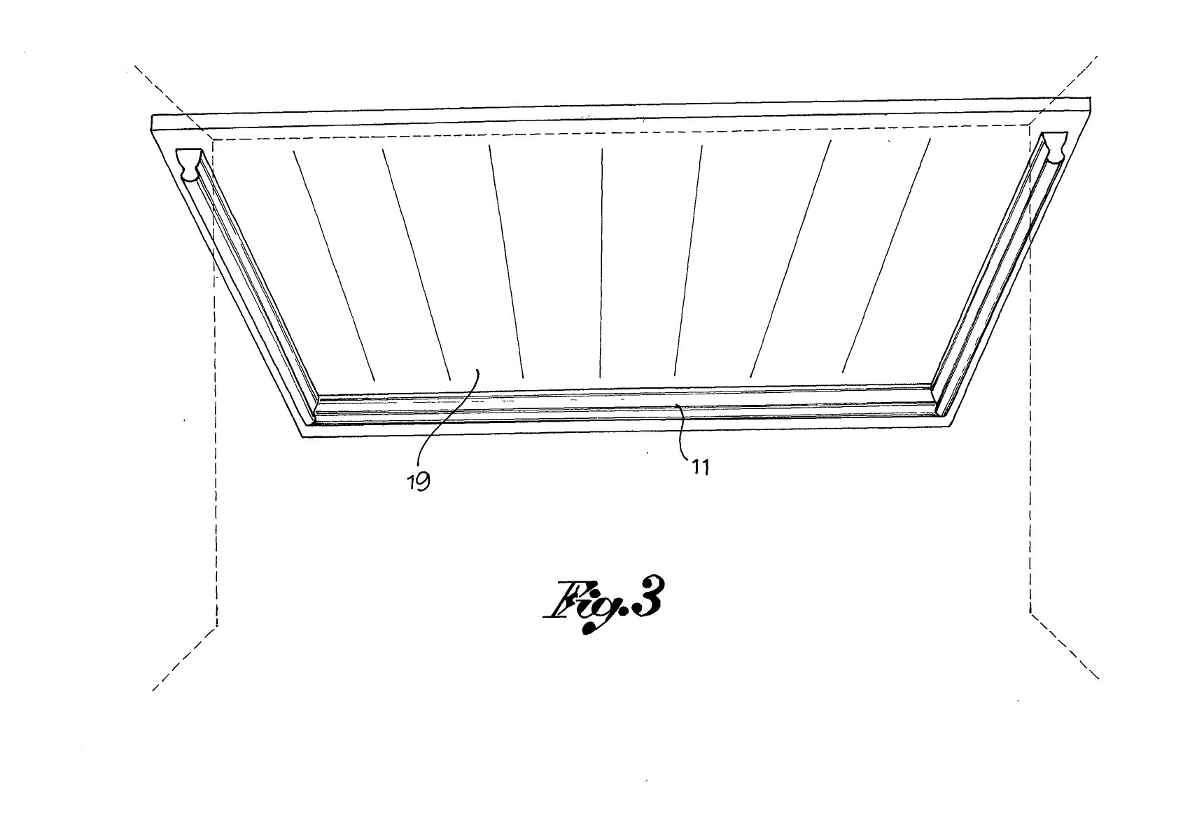

### DETAILED DESCRIPTION OF THE INVENTION

The safety edge shown comprises a soft extruded profile 11 made of rubber or other flexible material, which longitudinally exhibits a first seat 12 and a second seat 13, shaped as channels, parallel and open the one towards the other. The first longitudinal seat 12 is closer to the base 14 of the profile than the second channel-shaped seat 13.

The first longitudinal seat 12 houses and holds a first electrical conductor 15, and the other longitudinal seat 13 houses a second electrical conductor 16. The two conductors 15, 16 extend for the entire length of profile 11, and the first of them preferably exhibits a round, half-round, elliptical or similar section, whereas the second one preferably exhibits a flat section, such as in the shape of a tape, in any case flexible.

The first conductor 15 consists, for example, of a conductor braiding or mesh 17 arranged around an insulating core 18, and is exposed towards the second flat conductor 16 with a rounded portion of its surface. For the realisation of the edge, the soft profile 11 can be extruded around one or both conductors, embedding them. Or, conductors 15, 16 can be inserted into the respective seats 12, 13 of the soft profile 11 after its extrusion.

In any case, conductors 15, 16 remain parallel and normally separate from one another when the safety edge is at rest.

The edge thus structured is applied with its base 14 to the edges of a horizontally pivoted rolling gate 19, as shown in FIG. 3, for example, and conveniently inserted through the conductors into the electrical circuit of the motor unit controlling the gate.

As long as the edge is at rest, since it is not stressed by external thrusts, the conductors remain separate and the rolling gate operates normally. If during the rolling gate motion, any part of the edge meets an obstacle or a hindrance, so as to be stressed and compressed by an external source, the conductors close on one another, thus causing an immediate halt of

the motor unit, and thereby of the rolling gate. Given the shape and the association of the conductors, the safety edge trips in the presence of both orthogonal and inclined thrusts with respect to the profile base.

1. Improved safety edge for horizontally pivoted rolling gates actuated by a motor unit, characterised by a profile (11) made of rubber or other soft flexible material, having a base (14) for its application to a rolling gate, and by two electrical conductors (15, 16) extending longitudinally into said soft profile, parallel and normally separate from one another and movable closer in the presence of a deforming thrust on said profile to come into contact and enable an electrical circuit to send a signal for stopping the rolling gate motor unit.

2. Safety edge according to claim 1, wherein said soft profile (11) exhibits a first longitudinal channel-shaped seat (12) for receiving and holding a first conductor (15) and a second longitudinal channel-shaped seat (13) for receiving a second conductor (16) parallel to the first conductor, and wherein the first and the second seat are longitudinally open the one towards the other to allow an approach and a contact of the conductors in any part of their length in the presence of a thrust on parts of the profile opposed to its base.

3. Safety edge according to claims 1 and 2, wherein the first conductor (15) has a round, half-round, elliptical or similar section, with at least one part of rounded surface facing the second conductor, the second conductor having a flat section.

4. Safety edge according to claim 3, wherein the first conductor consists of a conductor braiding or mesh (17) arranged around an insulating core (18) and the second conductor consists of an element shaped as flexible tape.

5. Safety edge according to any one of the previous claims, wherein the first seat with the first conductor is closer to the profile base than the second seat with the second conductor.
